(19) United States
(12) Patent Application Publication
(10) Pub. No.: US 2004/0161652 A1
(43) Pub. Date: Aug. 19, 2004

(54) Alkaline fuel cell pack with gravity fed electrolyte circulation and water management system

(76) Inventors: Stanford R. Ovshinsky, Bloomfield Hills, MI (US); Zdravko Menjak, Troy, MI (US); Srinivasan Venkatesan, Southfield, MI (US); Latchezara Gradinarova, Rochester Hills, MI (US); Ana Menjak, Troy, MI (US); Hong Wang, Troy, MI (US); Peter Faguy, Rochester Hills, MI (US); Subhash K. Dhar, Bloomfield, MI (US)

Correspondence Address: ENERGY CONVERSION DEVICES, INC., 2956 WATERVIEW DRIVE, ROCHESTER HILLS, MI, 48309, US

(21) Appl. No.: 10/364,978

(22) Filed: Feb. 12, 2003

(51) Int. Cl. H01M 2/00

(52) U.S. Cl. 429/34

(57) ABSTRACT

An ambient temperature alkaline fuel cell pack supplied with a non-forced electrolyte and air stream which are circulated through the fuel cell pack via thermal convection resulting from heat produced during the reactions at the hydrogen and air electrodes.

### FIELD OF THE INVENTION

The present invention generally relates to alkaline fuel cells. In particular, the present invention relates to an alkaline fuel cell pack utilizing “air breathing” oxygen electrodes and non-forced convectional electrolyte circulation.

### BACKGROUND

As the world's population expands and its economy increases, the atmospheric concentrations of carbon dioxide are warming the earth causing climate change. However, the global energy system is moving steadily away from the carbon-rich fuels whose combustion produces the harmful gas. Experts say atmospheric levels of carbon dioxide may be double that of the pre-industrial era by the end of the next century, but they also say the levels would be much higher except for a trend toward lower-carbon fuels that has been going on for more than 100 years. Furthermore, fossil fuels cause pollution and are a causative factor in the strategic military struggles between nations. Furthermore, fluctuating energy costs are a source of economic instability worldwide.

In the United States, it is estimated, that the trend toward lower-carbon fuels combined with greater energy efficiency has, since 1950, reduced by about half the amount of carbon spewed out for each unit of economic production. Thus, the decarbonization of the energy system is the single most important fact to emerge from the last 20 years of analysis of the system. It had been predicted that this evolution will produce a carbon-free energy system by the end of the 21^{st} century. The present invention is another product which is essential to shortening that period to a matter of years. In the near term, hydrogen will be used in fuel cells for cars, trucks and industrial plants, just as it already provides power for orbiting spacecraft. But, with the problems of storage and infrastructure solved (see U.S. application Ser. No. 09/444,810, entitled “A Hydrogen-based Ecosystem” filed on Nov. 22, 1999 for Ovshinsky, et al., which is herein incorporated by reference and U.S. patent application Ser. No. 09/435,497, entitled “High Storage Capacity Alloys Enabling a Hydrogen-based Ecosystem”, filed on Nov. 6, 1999 for Ovshinsky et al., which is herein incorporated by reference), hydrogen will also provide a general carbon-free fuel to cover all fuel needs.

A dramatic shift has now occurred, in which the problems of global warming and climate change are now acknowledged and efforts are being made to solve them. Therefore, it is very encouraging that some of the world's biggest petroleum companies now state that they want to help solve these problems. A number of American utilities vow to find ways to reduce the harm done to the atmosphere by their power plants. DuPont, the world's biggest chemicals firm, even declared that it would voluntarily reduce its emissions of greenhouse gases to 35% of their level in 1990 within a decade. The automotive industry, which is a substantial contributor to emissions of greenhouse gases and other pollutants (despite its vehicular specific reductions in emissions), has now realized that change is necessary as evidenced by their electric and hybrid vehicles.

Hydrogen is the “ultimate fuel.” In fact, it is considered to be “THE” fuel for the future. Hydrogen is the most plentiful element in the universe (over 95%). Hydrogen can provide an inexhaustible, clean source of energy for our planet which can be produced by various processes. Utilizing the inventions of subject assignee, the hydrogen can be stored and transported in solid state form in trucks, trains, boats, barges, etc. (see the '810 and '497 applications).

A fuel cell is an energy-conversion device that directly converts the energy of a supplied gas into an electric energy. Researchers have been actively studying fuel cells to utilize the fuel cell's potential high energy-generation efficiency. The base unit of the fuel cell is a cell having an oxygen electrode, a hydrogen electrode, and an appropriate electrolyte. Fuel cells have many potential applications such as supplying power for transportation vehicles, replacing steam turbines and power supply applications of all sorts. Despite their seeming simplicity, many problems have prevented the widespread usage of fuel cells.

Presently most of the fuel cell R & D focus is on P.E.M. (Proton Exchange Membrane) fuel cells. The P.E.M. fuel cell suffers from relatively low conversion efficiency and has many other disadvantages. For instance, the electrolyte for the system is acidic. Thus, noble metal catalysts are the only useful active materials for the electrodes of the system. Unfortunately, not only are the noble metals costly, they are also susceptible to poisoning by many gases, and specifically carbon monoxide (CO). The proton exchange membrane itself is quite expensive, and because of its low conductivity, inherently limits the power performance and operational temperature range of the P.E.M. fuel cell (the P.E.M. is nearly non-functional at low temperatures, unlike the fuel cell of the instant invention). Also, the membrane is sensitive to high temperatures, and begins to soften at 120° C. The membrane's conductivity depends on water and dries out at higher temperatures, thus causing cell failure. Therefore, there are many disadvantages to the P.E.M. fuel cell which make it somewhat undesirable for commercial/consumer use.

The conventional alkaline fuel cell has some advantages over P.E.M. fuel cells in that they have higher operating efficiencies, they use less expensive materials of construction, and they have no need for expensive membranes. The alkaline fuel cell also has relatively higher ionic conductivity in the electrolyte, therefore it has a much higher power capability. Unfortunately, conventional alkaline fuel cells still suffer from certain disadvantages. For instance, conventional alkaline fuel cells still use expensive noble metals catalysts in both electrodes, which, as in the P.E.M. fuel cell, are susceptible to gaseous contaminant poisoning. While the conventional alkaline fuel cell is less sensitive to temperature than the P.E.M. fuel cell, the active materials of conventional alkaline fuel cell electrodes become very inefficient at low temperatures.

Fuel cells, like batteries, operate by utilizing electrochemical reactions. Unlike a battery, in which chemical energy is stored within the cell, fuel cells generally are supplied with reactants from outside the cell. Barring failure of the electrodes, as long as the fuel, preferably hydrogen, and oxidant, typically air or oxygen, are supplied and the reaction products are removed, the cell continues to operate.

Fuel cells offer a number of important advantages over internal combustion engine or generator systems. These include relatively high efficiency, environmentally clean operation especially when utilizing hydrogen as a fuel, high reliability, few moving parts, and quiet operation. Fuel cells potentially are more efficient than other conventional power sources based upon the Carnot cycle.

The major components of a typical fuel cell are the hydrogen electrode for hydrogen oxidation and the oxygen electrode for oxygen reduction, both being positioned in a cell containing an electrolyte (such as an alkaline electrolytic solution). Typically, the reactants, such as hydrogen and oxygen, are respectively fed through a porous hydrogen electrode and oxygen electrode and brought into surface contact with the electrolytic solution. The particular materials utilized for the hydrogen electrode and oxygen electrode are important since they must act as efficient catalysts for the reactions taking place.

In an alkaline fuel cell, the reaction at the hydrogen electrode occurs between hydrogen fuel and hydroxyl ions (OH⁻) present in the electrolyte, which react to form water and release electrons:

H₂+2OH⁻→2H₂O+2e⁻.

At the oxygen electrode, oxygen, water, and electrons react in the presence of the oxygen electrode catalyst to reduce the oxygen and form hydroxyl ions (OH⁻):

O₂+2H₂O+4e⁻→4OH⁻.

The flow of electrons is utilized to provide electrical energy for a load externally connected to the hydrogen and oxygen electrodes.

The catalyst in the hydrogen electrode of the alkaline fuel cell has to not only split molecular hydrogen to atomic hydrogen, but also oxidize the atomic hydrogen to release electrons. The overall reaction can be seen as (where M is the catalyst):

M+H₂→2MH→M+2H⁺+2e⁻.

Thus the hydrogen electrode catalyst must efficiently dissociate molecular hydrogen into atomic hydrogen. Using conventional hydrogen electrode material, the dissociated hydrogen atoms are transitional and the hydrogen atoms can easily recombine to form molecular hydrogen if they are not used very quickly in the oxidation reaction. With the hydrogen storage electrode materials of the inventive instant startup fuel cells, the atomic hydrogen is immediately captured and stored in hydride form, and then used as needed to provide power.

Fuel cells utilize gaseous hydrogen, gaseous oxygen, and electrolyte to produce power. The source of oxygen may be pure oxygen, air, or another oxygen containing mixture. Air, however, is the most abundant and attainable source of oxygen. Due to air containing only 21% oxygen, a greater air flow rate is needed when air is used as a source of oxygen, as compared to using pure oxygen. As a result of the high flow rate of the air stream, the pressure inside the fuel cell increases. The pressure increases inside fuel cells may cause design problems for other streams entering and exiting the fuel cell because the pressure of the streams will need to be adjusted according to the pressure within the fuel cell. As such, a fuel cell allowing for a high air flow rate while maintaining a low pressure within the fuel cell is very desirable.

To provide the fuel cell with the required supply of air and electrolyte, many fuel cells have used pumps or other flow management devices to supply the reactants throughout the fuel cell. With the large amount of air needed to operate a fuel cell, these pumps require a great deal of energy for operation which reduces the overall efficiency of the fuel cell. A fuel cell not requiring such pumps or flow management devices would therefore be much more energy efficient and desirable for systems utilizing fuel cells.

### SUMMARY OF THE INVENTION

An embodiment of the present invention discloses a fuel cell pack comprising a fuel cell stack including at least one hydrogen electrode having a hydrogen contacting surface and an electrolyte contacting surface and at least one air electrodes having an air contacting surface and an electrolyte contacting surface, and a convectional electrolyte circulating loop for supplying a stream of electrolyte to the fuel cell stack.

The electrolyte circulating loop includes an electrolyte reservoir positioned at a height higher than the height of the fuel cell stack. The electrolyte reservoir 1) is in continuous fluid communication with the fuel cell stack, 2) provides a stream of cooled electrolyte to the fuel cell stack via gravity feed, and 3) receives a heated stream of electrolyte from the fuel cell stack via thermal convection.

The electrolyte contacting surface of the air electrodes and the electrolyte contacting surfaces of the hydrogen electrodes are adjacent to an electrolyte chamber. The electrolyte chamber may be formed between the electrolyte contacting surface of the air electrodes and the electrolyte contacting surfaces of the hydrogen electrodes. A stream of electrolyte enters the bottom of the electrolyte chamber and a heated stream of electrolyte exits the top of the electrolyte chamber via thermal convection.

The hydrogen contacting surfaces of each of the hydrogen electrodes are adjacent to a hydrogen chamber. The hydrogen chamber may be formed between the hydrogen contacting surfaces of two of the hydrogen electrodes. An ambient pressure stream of hydrogen may be supplied to the hydrogen chamber at a rate equal to the consumption of hydrogen by said fuel cell stack eliminating the need for any excess hydrogen supply (and consequently a hydrogen outlet). Each of the hydrogen electrodes may be sealed in a hydrogen electrode frame exposing the hydrogen contacting surface and the electrolyte contacting surface of the hydrogen electrodes.

The air contacting surfaces of each of the air electrodes are adjacent an air flow-through passageway. A non-forced supply of air enters and exits the air flow-through passageway via thermal convection and/or an oxygen concentration gradient between outside air and oxygen depleted air within the fuel cell stack. The air flow-through passageway may be formed between the oxygen contacting surfaces of two of the air electrodes. Each of the air electrodes may be sealed in an air electrode frame exposing the air contacting surface and the electrolyte contacting surface of the air electrode.

The fuel cell pack further comprises a hydrogen supply subsystem and a protective casing. The protective casing has a plurality of openings through which air enters and exits the fuel cell pack via thermal convection and/or an oxygen concentration gradient between outside air and oxygen depleted air within the fuel cell stack. The hydrogen supply subsystem is in gaseous communication with the fuel cell stack. The hydrogen supply subsystem is adapted to receive a supply of hydrogen from at least one hydrogen storage container and distribute the supply of hydrogen to the fuel cell stack. The hydrogen storage containers are adapted to store hydrogen in a liquid form, gaseous form, a chemical hydride form, and/or a metal hydride form. When the hydrogen storage container stores hydrogen in a metal hydride form, the hydrogen storage container may be placed in thermal contact with a non-forced stream of heated air exiting the top of the fuel cell stack via convection to aid in desorption of hydrogen from the metal hydride. The electrolyte circulating loop may also be adapted to provide heat to the hydrogen storage containers to aid in desorption of hydrogen from the metal hydride.

### BRIEF DESCRIPTION OF THYE DRAWINGS

FIG. 1, shows an embodiment of the fuel cell pack in accordance with the present invention.

FIG. 2, show a view of the inner components of the fuel cell pack in accordance with the present invention.

FIG. 3, is a view of an embodiment of a fuel cell stack in accordance with the present invention.

FIG. 4, is an exploded view of an embodiment of a fuel cell stack in accordance with the present invention.

FIG. 5, is a depiction of an air electrode frame in accordance with the present invention.

FIG. 6, is a depiction of an endplate frame in accordance with the present invention.

FIG. 7, is a depiction of a hydrogen electrode frame in accordance with the present invention.

FIG. 8, is a depiction of a hydrogen spacer in accordance with the present invention.

FIG. 9, is a depiction of an electrolyte spacer in accordance with the present invention.

FIG. 10, shows the flow of hydrogen, air, and electrolyte through an embodiment of the fuel cell stack in accordance with the present invention.

FIG. 11, is a depiction of a hydrogen electrode in accordance with the present invention.

FIG. 12, is a depiction of an air electrode in accordance with the present invention.

### DETAILED DESCRIPTION OF PREFERRED EMBODIMENTS OF THE INVENTION

The present invention comprises a fuel cell pack with non-forced air and electrolyte circulation. The fuel cell pack is capable of providing a high power output without having forced high flow rates of hydrogen, oxygen/air, or electrolyte, thus eliminating the need for any pumping devices. Non-forced air and electrolyte circulation allow the fuel cell pack to be operated at ambient temperatures and pressures. Air enters and exits the fuel cell stack via thermal convection and/or an oxygen concentration gradient between outside air and oxygen depleted air contained within the fuel cell stack. Electrolyte is circulated throughout the fuel cell via thermal convection and/or gravity. During operation, utilizing the density difference between hot and cold electrolyte, heated electrolyte flows upwards through the fuel cell pack while cooler electrolyte flows downward thereby providing non-forced convectional electrolyte circulation utilized for operation of the fuel cell pack. During operation of the fuel cell pack, cool air enters the fuel cell pack through the bottom and sides via thermal convection and/or the oxygen concentration gradient, is heated by the energy dissipated by the electrodes (I²R heating), and exits through the top of the fuel cell pack thereby providing non-forced circulation of air through the fuel cell pack.

As used herein the term “non-forced”, when referring to a gaseous or liquid stream, refers to the circulation of the stream throughout the fuel cell pack without the use of pumps or other pumping devices e.g. fans, blowers, etc. As used herein the term “thermal convection” refers to the transfer of heat through a fluid caused by molecular motion resulting in the circulation of such fluid.

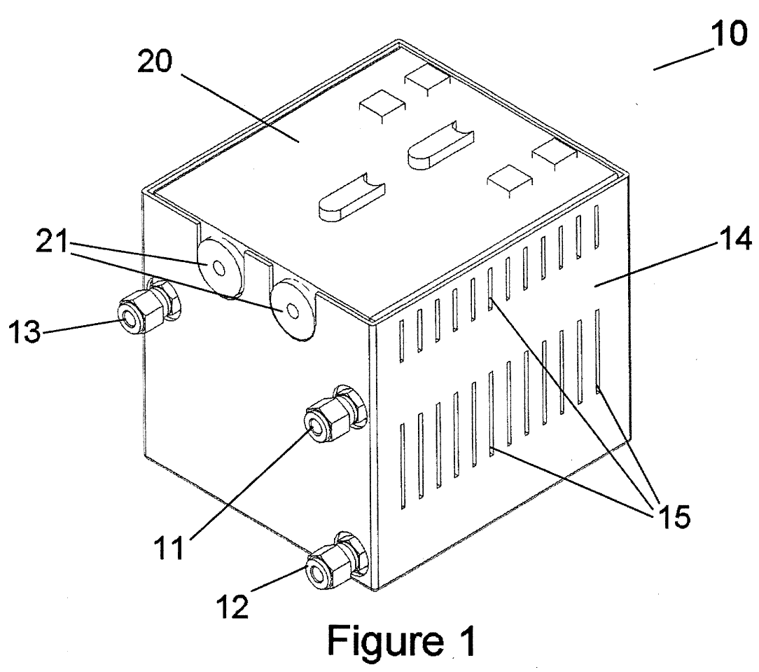

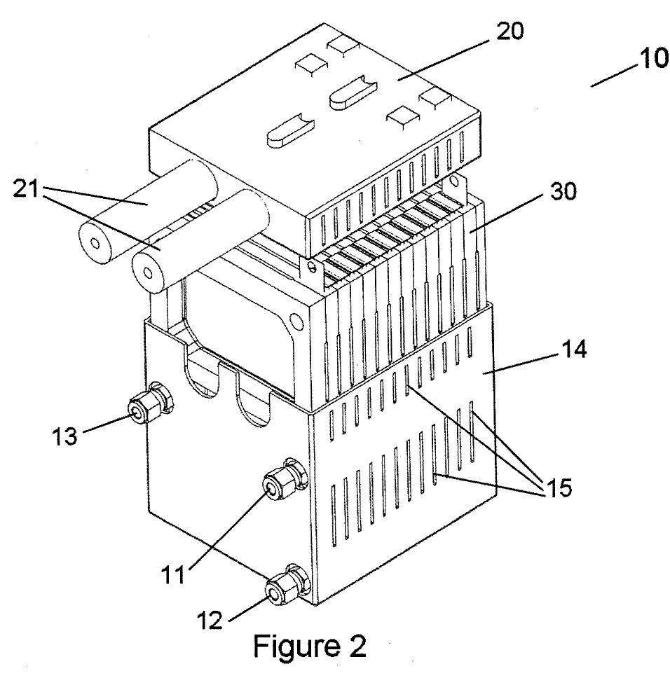

Depicted in FIG. 1 and FIG. 2, are views of an embodiment of the fuel cell pack 10 in accordance with the present invention. The fuel cell pack includes a hydrogen supply subsystem 20, a fuel cell stack 30, a hydrogen inlet 11, an electrolyte inlet 12, and an electrolyte outlet 13. The fuel cell also includes a specially designed case 14 having multiple openings 15 through which air enters and exits the fuel cell pack.

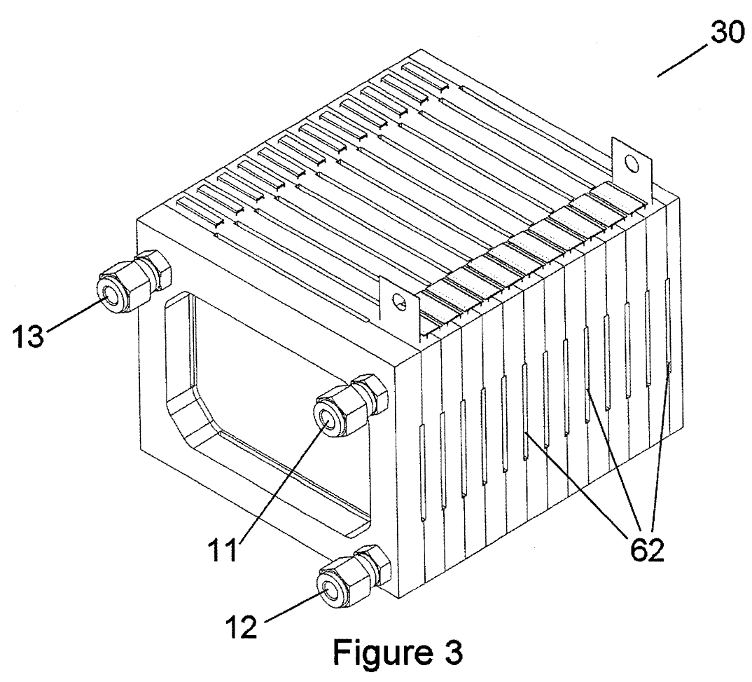

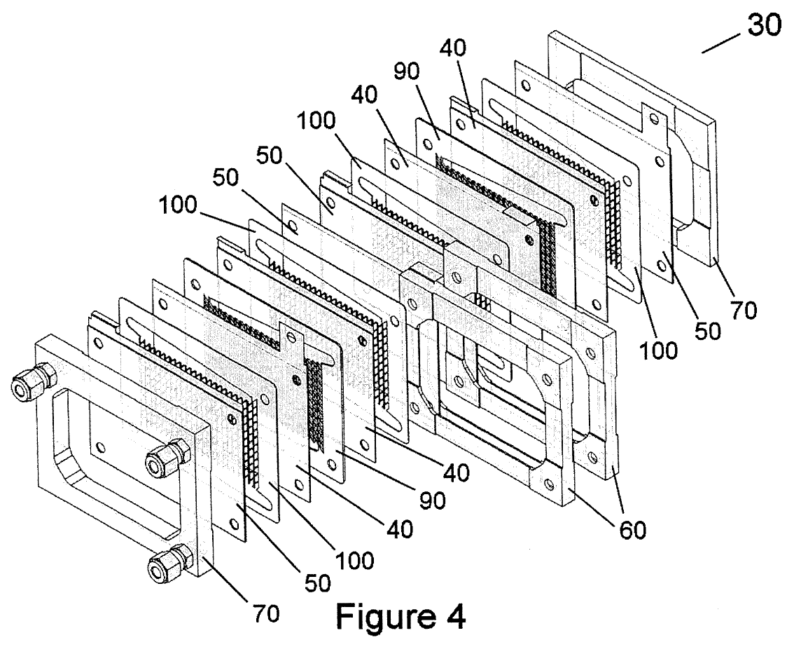

A view of an embodiment of a fuel cell stack in accordance with the present invention is depicted in FIG. 3 and an exploded view of the fuel cell stack 30 is shown in FIG. 4. The layers of the fuel cell stack 30 have multiple openings through which hydrogen and electrolyte reach the electrodes. When the layers are stacked and pressed together, the holes of each layer line up to allow uninterrupted flow throughout the cell. The fuel cell stack is easily expandable as dictated by design requirements. In such case additional layers such as hydrogen electrodes, air electrodes, hydrogen electrode spacers, air electrode spacers, air electrode frames, and electrolyte spacers may be added to achieve desired power output requirements. The layers of the fuel cell stack are bonded together using epoxy or other adhesive agents such that all layers are sealed together to limit hydrogen, air, and electrolyte movement to their respective regions within the fuel cell stack.

The fuel cell stack 30 includes at least one hydrogen electrode 40 and at least one air electrode 50. The oxygen electrodes each have an air contacting surface and an electrolyte contacting surface and the hydrogen electrodes each have a hydrogen contacting surface and an electrolyte contacting surface.

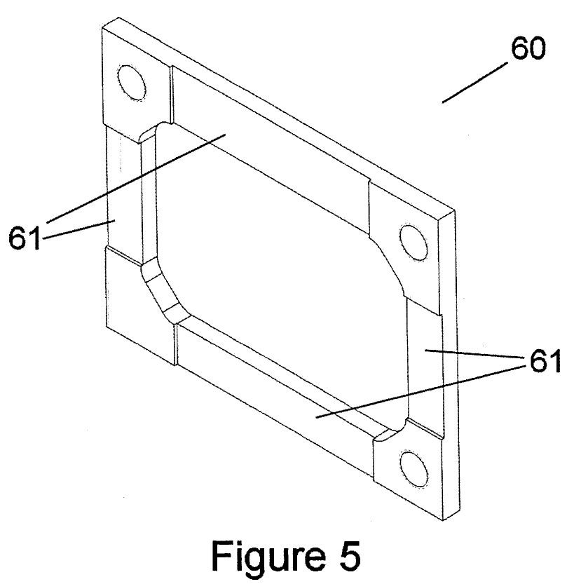

The air electrodes utilized in the fuel cell stack may each be placed inside air electrode frames 60. When placed in the air electrode frame 60, the air electrode may be recessed from either side of the air electrode frame. A depiction of an air electrode frame in accordance with the present invention is shown in FIG. 5. The air electrode frames are each adapted to receive an air electrode. The air electrodes are sealed into each frame such that electrolyte solution cannot penetrate into the air contacting side and vice versa. The air electrode frames allow air to freely contact the air contacting surface of the air electrodes and allow electrolyte to contact the electrolyte contacting surface of the oxygen electrode. Each air electrode frame has an air contacting side and a electrolyte contacting side corresponding to the air contacting surface and the electrolyte contacting surface of the air electrodes. The air contacting side of the air electrode frames have multiple depressions 61 located on the top, bottom, and sides of the air contacting side. When the air contacting sides of two air electrode frames are placed in contact with one another an air flow-through passageway is formed between the air contacting surfaces of the air electrodes, and the depressions line up to form air openings 62 through which air enters and exits the air flow-through passageway. The electrolyte contacting side of the air electrode frame may have one or more depressions which allow electrolyte to contact the electrolyte contacting surface of the air electrode.

The air electrode frames may also be used as endplates for the fuel cell stack. At the end of the fuel cell stack, there is no air flow-through passageway formed with another framed air electrode, however, air is available to contact the air contacting surface of the air electrode through the frame opening.

Alternatively, the air electrodes within the fuel cell stack may not be placed in air electrode frames. In such case, an air electrode spacer may be placed between the air contacting surfaces of two air electrodes forming an air flow-through passageway. The air electrode spacer is designed to form openings when placed between the air contacting surfaces of the air electrodes through which air can enter and exit the air flow-through passageway. The air electrode spacer may also be adapted to provide mechanical support to the fuel cell stack.

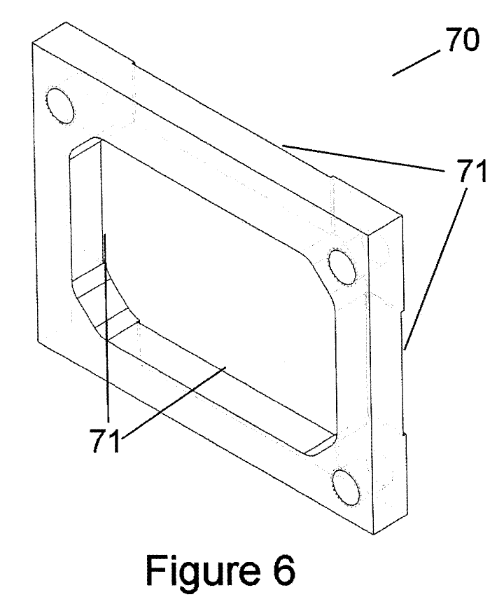

To provide additional support to the fuel cell stack when non-framed air electrodes are utilized, endplate frames 70 may be used to provide support to the fuel cell stack 30 while providing the air electrodes at the end of the fuel cell stack with air. A depiction of an endplate frame 70 in accordance with the present invention is shown in FIG. 6. The endplate frames 70 are pressed against the outer air electrodes such that air can freely contact the air contacting surface of the air electrode while support is provided to the fuel cell stack. The endplate frames may be flat or have depressions 71 on the face in contact with the air electrode. The depressions may be located on the top, bottom, and sides of the frame side in contact with the air contacting surface of the air electrode. When pressed against the air electrode, the depressions form openings which aid in supplying air to the air contacting surface of the air electrode.

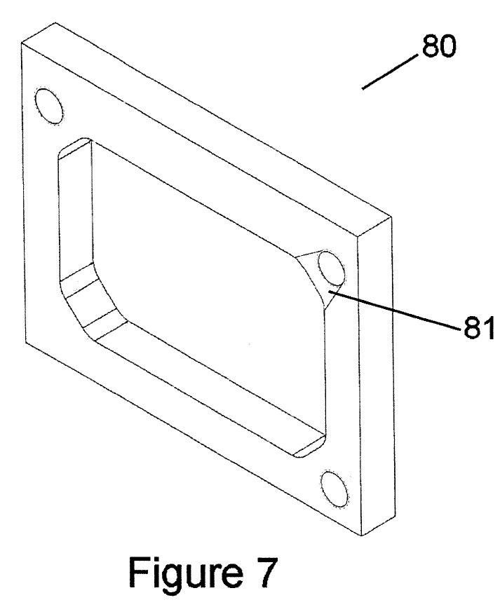

The hydrogen electrodes 40 contained within the fuel cell stack 30 may each be placed inside hydrogen electrode frames. When placed in hydrogen electrode frames, the hydrogen electrodes may be recessed from either side of the hydrogen electrode frame. A depiction of a hydrogen electrode frame in accordance with the present invention is shown in FIG. 7. The hydrogen electrode frames allow hydrogen to freely contact the hydrogen contacting surface of the hydrogen electrodes and allow electrolyte to contact the electrolyte contacting surface of the hydrogen electrode. The hydrogen electrode frames are each adapted to receive a hydrogen electrode 40. The hydrogen electrodes 40 are sealed into each frame such that electrolyte solution cannot penetrate into the hydrogen contacting side and vice versa. The hydrogen electrode frames each have a hydrogen contacting side and an electrolyte contacting side corresponding to the hydrogen contacting surface and the electrolyte contacting surface of the hydrogen electrode. The hydrogen contacting side of the hydrogen electrode frames may have one or more depressions 81. When the hydrogen contacting sides of two of the framed hydrogen electrodes are pressed together, a hydrogen chamber is formed between the hydrogen contacting surfaces of the hydrogen electrodes and the depressions line up to form an opening through which hydrogen enters the hydrogen chamber. The electrolyte contacting side of the hydrogen electrode frame may have one or more depressions similar to the depressions on the hydrogen contacting side which allow electrolyte to contact the electrolyte contacting surface of the hydrogen electrode.

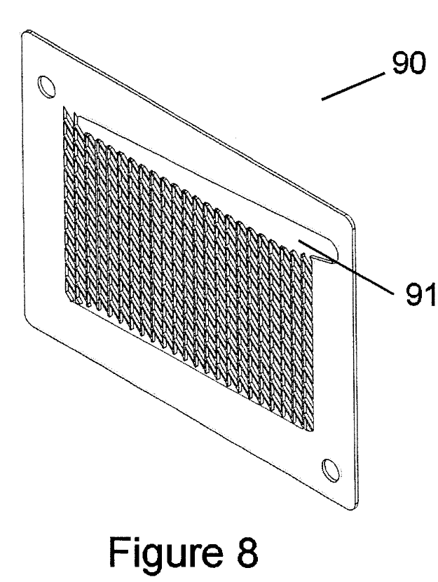

Alternatively, the hydrogen electrodes may not be placed in hydrogen electrode frames. In such case, a hydrogen spacer 90 is placed between the hydrogen contacting surfaces of the hydrogen electrodes forming a hydrogen chamber. The hydrogen electrodes and the hydrogen electrode spacer are sealed together to prevent any hydrogen from leaking out of the hydrogen chamber. A depiction of a hydrogen electrode spacer as used in accordance with the present invention is shown in FIG. 8. Hydrogen enters the hydrogen chamber through a passage formed from a cutout section 91 in the hydrogen electrode spacer 90. The hydrogen electrode spacer 90 may be adapted to distribute hydrogen across the hydrogen contacting surfaces of the hydrogen electrodes and provide mechanical support to the fuel cell stack.

Electrolyte chambers are formed within the fuel cell stack between the electrolyte contacting surfaces of the hydrogen and air electrodes. This may be accomplished by utilizing framed electrodes or by positioning an electrolyte spacer between the electrolyte contacting surfaces of the air electrode and the hydrogen electrode.

When utilizing framed electrodes within the fuel cell stack, the electrolyte contacting sides of the framed air electrodes and framed hydrogen electrodes are pressed together forming an electrolyte chamber between the recessed electrodes in each frame. The depressions in the electrolyte contacting side of the air electrode frame and the hydrogen electrode frame line up to form openings through which electrolyte enters and exits the electrolyte chamber. The hydrogen electrode frame and the air electrode frame are sealed together such that no electrolyte solution can leak out of the electrolyte chamber.

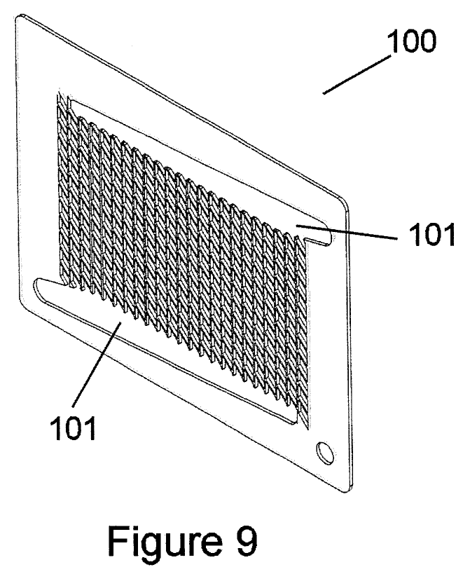

When some or all of the hydrogen electrodes and air electrodes are not framed within the fuel cell stack, an electrolyte spacer 100 is positioned between the electrolyte contacting surfaces of the air electrode and hydrogen electrode forming an electrolyte chamber. A depiction of an electrolyte spacer in accordance with the present invention is shown in FIG. 9. The electrolyte spacer 100 is sealed against the electrolyte contacting surface of the air electrode and the electrolyte contacting surface of the hydrogen electrode such that no electrolyte solution can leak out of the electrolyte chamber. The electrolyte spacer 100 has cutout sections 101 which form openings through which electrolyte solution enters and exits the electrolyte chamber. The electrolyte spacer may be adapted to aid in distribution of electrolyte across the surfaces of the electrodes and provide mechanical support of the fuel cell stack.

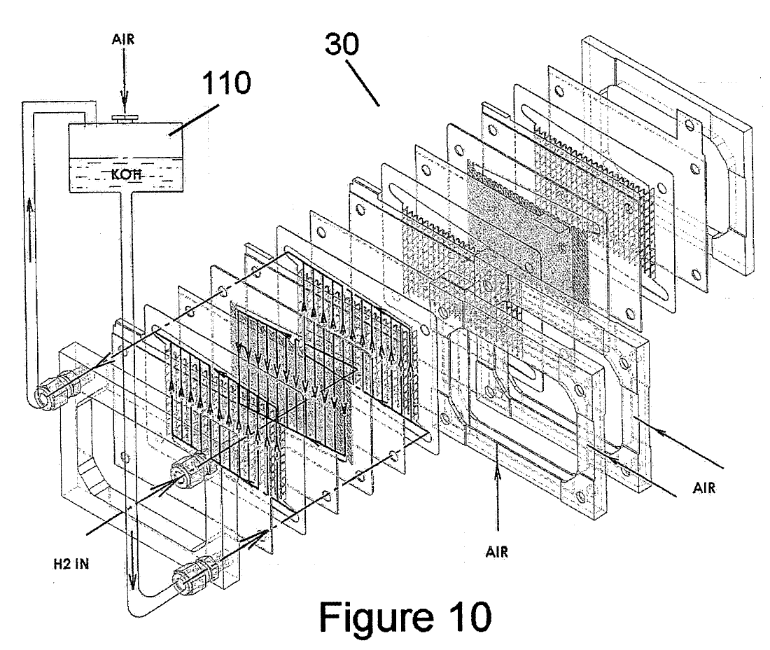

The “air breathing” air electrodes of the present invention receive their supply of air from air. A depiction of the non-forced flow of air through the fuel cell stack is shown in FIG. 10. Air is supplied from the atmosphere to the fuel cell pack through openings in the side and bottom of the fuel cell pack casing. Upon entering the casing, air enters into the air flow-through passageway through openings formed between the air electrodes. Inside the air flow-through passageway, air contacts the air contacting surfaces of the air electrodes and supplies oxygen for the air electrode oxidation reactions. The oxygen concentration gradient between air outside the fuel cell stack and air within the fuel cell stack and/or thermal convection from heat produced within the fuel cell stack cause circulation of the air stream. As the warm oxygen depleted air rises and exits through the top of the fuel cell pack, cool air enters the air flow-through passageway and replaces the warmed oxygen depleted air to maintain operation of the fuel cell pack.

A depiction of the flow of hydrogen from the hydrogen inlet to the hydrogen chambers of the fuel cell stack is shown in FIG. 10. During operation of the fuel cell stack, hydrogen is continually supplied through the hydrogen inlet of the fuel cell pack from a hydrogen supply subsystem contained within or proximate to the fuel cell pack. Hydrogen enters the hydrogen inlet of the fuel cell pack and flows through a passage formed by openings in each layer of the fuel cell stack to reach the hydrogen chambers. The hydrogen enters the hydrogen chambers through one or more hydrogen flow channels formed by cutout sections in hydrogen electrode spacers located between the hydrogen electrodes or hydrogen electrode frames and is distributed across the hydrogen contacting surfaces of both of the hydrogen electrodes by the hydrogen electrode spacer. The flow of hydrogen from the hydrogen supply subsystem is designed to allow all of the hydrogen input into the fuel cell stack to be consumed by the hydrogen electrodes, thereby eliminating the need for a hydrogen outlet. This mode is generally known as a “dead end supply.” The hydrogen supply subsystem maintains a continual supply of hydrogen to the hydrogen electrodes by supplying hydrogen to the fuel cell stack at a pressure slightly higher than the pressure inside the hydrogen chambers, essentially replacing the hydrogen consumed within the hydrogen chambers. To maintain a continual supply of hydrogen to the hydrogen electrodes for various power outputs, the pressure of the hydrogen supply may need to be varied accordingly to accommodate increases and decreases in the amount of hydrogen consumed by the hydrogen electrodes.

A depiction of the non-forced convectional flow of electrolyte solution through the electrolyte loop of the fuel cell stack is shown in FIG. 10. The flow of electrolyte solution throughout the electrolyte loop occurs via convection without the need for pumping devices. The non-forced convectional electrolyte circulation enables excellent electrochemical activity and a long electrode lifetime in addition to lowering the parasitic power losses. The electrolyte loop maintains a continual supply of electrolyte within the fuel cell stack at all times. During operation of the fuel cell stack, non-forced convectional flow of electrolyte throughout the electrolyte loop results from the electrolyte being heated in the electrolyte chamber by the exothermic reactions occurring at the electrolyte contacting surfaces of the electrodes. As the electrolyte solution is heated, the electrolyte solution begins to rise via convection and exits the electrolyte chamber. Upon exiting the electrolyte chamber, the heated electrolyte solution continues to flow through a passage formed by openings in each layer of the fuel cell stack and exits through the electrolyte outlet. The heated electrolyte solution continues to rise until it reaches an electrolyte reservoir 110, positioned at a height higher than the fuel cell stack 30, where it is cooled to ambient temperatures. As the heated electrolyte solution rises through the electrolyte loop, cooled electrolyte from the electrolyte reservoir 110 flows down through the electrolyte loop via gravity. The cooled electrolyte enters the fuel cell stack through the electrolyte inlet, flows through a passage formed by openings in each layer for the fuel cell stack to reach the electrolyte chambers, and replaces the heated electrolyte exiting the electrolyte chamber. The electrolyte reservoir also allows for removal of gas bubbles and water produced by the operating cell. Gas bubbles and water vapor produced at the hydrogen electrode during operation of the fuel cell in the electrolyte solution rise with the warm electrolyte and exit the system through an opening in the electrolyte reservoir.

An embodiment of the hydrogen supply subsystem 20 in accordance with the present invention, is adapted to connect to at least one hydrogen storage container 21 and supply hydrogen from the hydrogen storage containers to the fuel cell stack at various pressures. The hydrogen storage containers may be contained inside or outside of the hydrogen supply subsystem depending on design requirements. The hydrogen storage containers may store hydrogen in either gaseous, liquid, chemical hydride, or metal hydride form. The disposable hydrogen storage containers are connected to the hydrogen supply subsystem, which supplies hydrogen to the hydrogen inlet of the fuel cell pack. The hydrogen storage containers may be connected to the hydrogen supply subsystem using fast coupling connectors and tubes suitable for hydrogen transfer. When the hydrogen supply inside the hydrogen storage containers is expended, the empty containers are removed from the hydrogen supply subsystem and replaced with full containers.

Hydrogen storage containers may utilize a chemical hydride which irreversibly stores hydrogen in hydride form. When brought into contact with water, the chemical hydride reacts and produces gaseous hydrogen. Examples of chemical hydrides are alkali metal hydrides, such as lithium borohydride (LiBH₄), sodium borohydride (NaBH₄), lithium aluminum hydride (LiAlH₄), and sodium aluminum hydride (NaAlH₄). Hydrogen storage containers utilizing chemical hydrides may incorporate a water delivery system to introduce a calculated amount of water to the chemical hydride to provide a desired quantity of hydrogen from the chemical hydride at a specific pressure.

The hydrogen supply subsystem may utilize a heat management system to aid in removal of hydrogen from the hydrogen storage containers utilizing a hydrogen storage alloy. When hydrogen is stored in metal hydride form, heat is required to desorb hydrogen from the metal hydride. In cold temperatures, the desorption of hydrogen from metal hydrides is kinetically unfavorable, which may pose a problem when trying to provide a continual source of hydrogen from the metal hydride. A considerable amount of heat is produced within the fuel cell stack and is removed by air and electrolyte utilized within the fuel cell stack via convection. To utilize the heat being removed from the system, the hydrogen storage containers may be placed in thermal contact with the heated air and electrolyte exiting the fuel cell stack. Preferably, the hydrogen storage containers utilized in the hydrogen storage subsystem are positioned above the fuel cell stack such that hydrogen storage containers are in thermal contact with the heated air exiting through the top of the fuel cell stack via convection. Specific structures, such as heat fins, may also be used within the hydrogen supply subsystem to transfer as much heat as possible from the heated oxygen depleted air exiting the fuel cell stack to the hydrogen storage containers. The hydrogen supply subsystem may also include a heat exchanger used to heat the hydrogen storage containers with the heated electrolyte exiting the fuel cell stack.

Water is produced as a product of the oxidation and reduction reactions taking place at the electrodes. A build-up of water in the electrolyte solution may cause a decrease in performance of the fuel cell. Excess water that is not removed as water vapor through the electrolyte reservoir may be removed from the electrolyte solution through various conventional methods, such as wicking, evaporation, etc. Water vapor, however, may also exit the fuel cell stack with the exiting air. During operation of the fuel cell pack, heat resulting from the oxidation and reduction reactions taking place at the electrodes causes water formed as a result of such reactions to be in the vapor form. This water vapor may diffuse through the air electrode and exit the fuel cell pack with the warmed air.

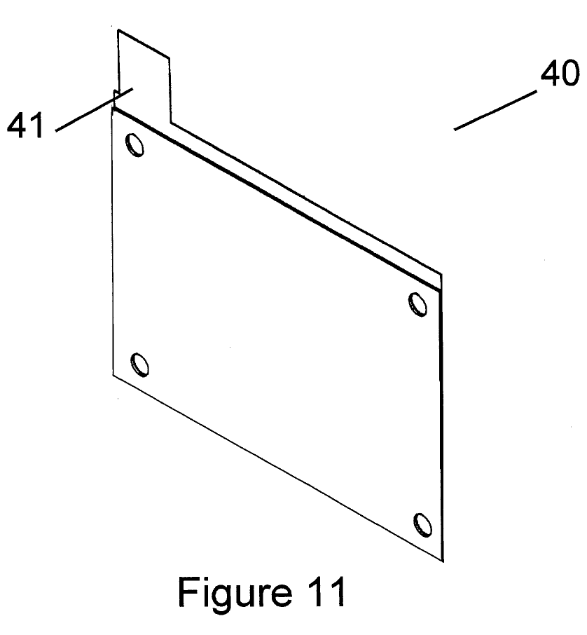

A hydrogen electrode 40 in accordance with the present invention is shown in FIG. 11. The hydrogen electrode 40 may be comprised of an active hydrogen electrode material supported by at least one current collector grid 41. The active hydrogen electrode material may be composed of Raney nickel, a hydrophobic binder material, and a conductive material, and optionally a Misch metal hydrogen storage alloy. A preferred composition of the active hydrogen electrode material in accordance with the present invention may be by weight 80 to 92% Raney catalytic material, 0.0 to 8.0% Misch Metal hydrogen storage alloy, 8.0% teflon, and 4.0% graphite.

The current collector grids in accordance with the present invention may be selected from, but not limited to, an electrically conductive mesh, grid, foam, expanded metal, or combination thereof. A preferred current collector grid is an electrically conductive mesh having approximately 40 wires per inch horizontally and approximately 20 wires per inch vertically, although other meshes may work equally well. The wires comprising the mesh may have a diameter between 0.005 inches and 0.01 inches, preferably between 0.005 inches and 0.008 inches. This design provides enhanced current distribution due to the reduction of the ohmic resistance. However, where more than 20 wires per inch are vertically positioned, problems may be encountered when affixing the active material to the substrate. One current collector grid may be used in accordance with the present invention, however the use of two or more current collector grids may be used to further increase the mechanical integrity of the electrode.

To produce the hydrogen electrode, the components are mixed together and rolled into ribbons of active hydrogen electrode material. The ribbon of active hydrogen storage material/catalyst is placed between two current collector grids and re-rolled to form the hydrogen electrode. Typically, the hydrogen electrode is sintered in nitrogen at 320° C. for half an hour then cooled to room temperature in a nitrogen environment. Other sintering environments and temperatures may be utilized.

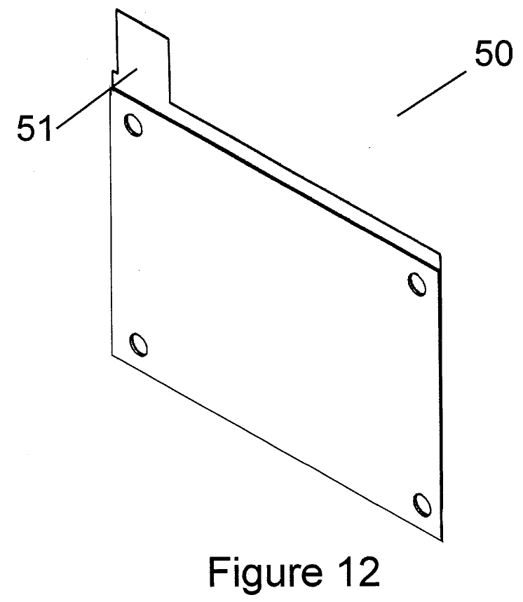

An air electrode 50 in accordance with the present invention is shown in FIG. 12. The air electrode may be composed of an active material layer having a built-in hydrophobic character, a gas diffusion layer having a greater built-in hydrophobic character than the active material layer, and at least one current collector grid 51. The active material layer and the gas diffusion layer are positioned adjacent to each other and supported by at least one current collector grid. The current collector grid may be the same as used for the hydrogen electrode.

The gas diffusion layer of the air electrode in accordance with the present invention is composed of a teflonated carbon matrix. The teflonated carbon matrix may be comprised of 40% teflonated acetylene black carbon or 60% teflonated Vulcan XC-72 carbon (Trademark of Cabot Corp.).

The active material layer of the air electrode in accordance with the present invention is prepared by first preparing a carbon matrix. The carbon matrix is composed of carbon particles coated with PTFE. The carbon particles are preferably carbon black particles, such as Black Pearl 2000 (Trademark of Cabot Corp.). The carbon/PTFE black mixture contains approximately 10 to 20 percent PTFE with the remainder being carbon black particles.

To prepare the air electrode, the gas diffusion layer is first deposited onto a current collector grid. Approximately 6-10 g of gas diffusion layer material is deposited onto the current collector grid per 100 cm². The active material layer is then deposited onto the gas diffusion layer. Approximately 2-3 grams of active material layer material is deposited onto the gas diffusion layer per 100 cm². After depositing the gas diffusion layer, a second current collector grid is placed on top of the active material layer to complete the air electrode. The air electrode is hot pressed at a pressure of 0.3 tons per cm². The electrode is subsequently cooled to room temperature.

The active material layer of the air electrode is then impregnated with an active catalyst material. The air electrode is dipped into an aqueous solution of an active catalyst material precursor. The active catalyst material precursor may be a 1M AgNO₃ solution containing 10% by weight sugar as a reducing agent. Once submerged in the aqueous active catalyst material precursor solution, the solution may be pulled into the active material layer under vacuum. The varying layers of hydrophobicity between the gas diffusion layer and the active material layer allow the solution to penetrate into the pores within the active material layer and not penetrate into the gas diffusion layer. The active catalyst material is deposited from the aqueous solution in the pores within the active material layer and any air or gases present in the solution pass through the gas diffusion layer. In addition to dipping in the aqueous solution, the impregnation may be performed by spraying or spreading the active catalyst on the electrode surface. After removing the air electrode from the active catalyst material solution, the air electrode is dried at room temperature. The air electrode is then heat treated at 50 degrees Celsius to remove any water from the electrode. Remaining in the pores of the active material layer are excess nitrate from the active catalyst precursor. The air electrode may then be heat treated at 300-375 degrees Celsius for half an hour to decompose any remaining nitrates into oxides. Depending upon the catalyst used, these oxides may further decompose to produce their parent metal catalysts. To add more catalyst the above process is repeated as necessary. The air electrode is then cooled and ready for use. After impregnation, the active catalyst material forms submicron to nano particles of the active catalyst material within the carbon matrix.

The foregoing is provided for purposes of explaining and disclosing preferred embodiments of the present invention. Modifications and adaptations to the described embodiments, particularly involving changes to the shape of the fuel cell and components thereof and varying electrode compositions will be apparent to those skilled in the art. These changes and others may be made without departing from the scope or spirit of the invention in the following claims.

1. A fuel cell pack comprising:
a fuel cell stack including at least one hydrogen electrode having a hydrogen contacting surface and an electrolyte contacting surface and at least one air electrode having an air contacting surface and an electrolyte contacting surface;
a convectional electrolyte circulating loop for supplying a stream of electrolyte to said fuel cell stack.

2. The fuel cell pack according to claim 1, wherein said electrolyte circulating loop comprises:
an electrolyte reservoir positioned at a height higher than the height of said fuel cell stack;
wherein said electrolyte reservoir 1) is in fluid communication with said fuel cell stack, 2) provides a stream of cooled electrolyte to said fuel cell stack via a gravity feed, and 3) receives a heated stream of electrolyte from said fuel cell stack via thermal convection.

3. The fuel cell pack according to claim 2, wherein said electrolyte contacting surface of said air electrodes and said electrolyte contacting surfaces of said hydrogen electrodes are adjacent an electrolyte chamber.

4. The fuel cell pack according to claim 3, wherein said electrolyte chamber is formed between said electrolyte contacting surface of said air electrodes and said electrolyte contacting surfaces of said hydrogen electrodes.

5. The fuel cell pack according to claim 3, wherein said cooled stream of electrolyte enters the bottom of said electrolyte chamber and said heated stream of electrolyte exits the top of said electrolyte chamber via thermal convection.

6. The fuel cell pack according to claim 1, wherein each of said hydrogen contacting surfaces of said hydrogen electrodes are adjacent a hydrogen chamber.

7. The fuel cell pack according to claim 6, wherein said hydrogen chamber is formed between said hydrogen contacting surfaces of two of said hydrogen electrodes.

8. The fuel cell pack according to claim 6, wherein an ambient pressure stream of hydrogen is supplied to said hydrogen chamber at a rate equal to the consumption of hydrogen by said fuel cell stack.

9. The fuel cell pack according to claim 1, wherein each of said hydrogen electrodes are sealed in a hydrogen electrode frame exposing said hydrogen contacting surface and said electrolyte contacting surface of said hydrogen electrode.

10. The fuel cell pack according to claim 1, wherein each of said air contacting surfaces of said air electrodes are adjacent an air flow-through passageway.

11. The fuel cell pack according to claim 10, wherein a non-forced stream of air enters said air flow-through passageway via thermal convection and a non-forced oxygen depleted stream of air exits said air flow-through passageway via thermal convection and/or an oxygen concentration gradient.

12. The fuel cell pack according to claim 10, wherein said air flow-through passageway is formed between said air contacting surfaces of two of said air electrodes.

13. The fuel cell pack according to claim 1, wherein each of said air electrodes are sealed in an air electrode frame exposing said air contacting surface and said electrolyte contacting surface of said air electrode.

14. The fuel cell pack according to claim 1, further comprising:
a hydrogen supply subsystem; and
a protective casing.

15. The fuel cell pack according to claim 14, wherein said hydrogen supply subsystem is in gaseous communication with said fuel cell stack, said hydrogen supply subsystem being adapted to receive a supply of hydrogen from at least one hydrogen storage container and distribute said supply of hydrogen to said fuel cell stack.

16. The fuel cell pack according to claim 15, wherein said hydrogen storage containers are adapted to store hydrogen in a liquid form, gaseous form, a chemical hydride form, and a metal hydride form.

17. The fuel cell pack according to claim 15, wherein said hydrogen storage containers are adapted to store hydrogen in a metal hydride form.

18. The fuel cell pack according to claim 17, wherein said hydrogen storage container is placed in thermal contact with a non-forced stream of heated air exiting the top of said fuel cell stack via convection to aid in desorption of hydrogen from said metal hydride.

19. The fuel cell pack according to claim 17, wherein said electrolyte circulating loop is adapted to provide heat to said hydrogen storage containers to aid in desorption of hydrogen from said metal hydride.

20. The fuel cell pack according to claim 14, wherein said protective casing has a plurality of openings through which air enters and exits said fuel cell pack via thermal convection and/or an oxygen concentration gradient.
